(19) United States
(12) Patent Application Publication
(10) Pub. No.: US 2018/0029719 A1
(43) Pub. Date: Feb. 1, 2018

(54) DRAG REDUCING LINER ASSEMBLY AND METHODS OF ASSEMBLING THE SAME

(71) Applicant: The Boeing Company, Chicago, IL (US)

(72) Inventors: Jesse Ian Follet, Bellingham, WA (US); Belur N. Shivashankara, Bellevue, WA (US); Zachariah Beach VanDeMark, Snohomish, WA (US); Leonard J. Hebert, Kirkland, WA (US)

(21) Appl. No.: 15/222,330

(22) Filed: Jul. 28, 2016

(51) Int. Cl. B64D 29/00; B64F 5/10; F01D 25/24

(52) U.S. Cl. CPC B64D 29/00; F01D 25/24; B64F 5/10; F05D 2220/323; F05D 2230/60; F05D 2260/97

(57) ABSTRACT

A liner assembly includes a core and a septum coupled to the core. The liner assembly also includes a facesheet coupled to the septum. The facesheet includes a plurality of slots defined therethrough. Each slot of the plurality of slots includes a major axis oriented perpendicular to a centerline of the liner assembly.

### BACKGROUND

The field of the disclosure relates generally to drag reduction, and, more particularly, to a drag reducing liner assembly and methods of assembling the same.

At least some known engines, such as some known jet engines and turbofan jet engines, are surrounded by a generally barrel-shaped nacelle and a core casing that covers the core engine. Such engines, and the airflow moving therethrough, generate an undesired amount of noise. As such, at least some known engines include an acoustic liner mounted on exposed surfaces of the engine, nacelle, and housing to dampen the noise level. More specifically, such acoustic liners include a honeycomb core coupled to a facesheet including a plurality of holes defined therethrough. In at least some known acoustic liners, the holes are either circular or elongated in the direction of the airflow. Sound waves generated inside the engine propagate forward and enter the cells of the honeycomb core through the facesheet and reflect from a backsheet at a phase different from the entering sound waves to facilitate damping the incoming sound waves and attenuating the overall noise level.

However, the air flowing over the holes defined in the facesheet cause an undesired amount of surface drag, which can reduce the efficiency of the engine. Additionally, the cost and time required to form the amount of holes in the facesheet required to achieve the desired acoustic performance is extensive.

### BRIEF DESCRIPTION

In one aspect, a liner assembly is provided. The liner assembly includes a core and a septum coupled to the core. The liner assembly also includes a facesheet coupled to the septum. The facesheet includes a plurality of slots defined therethrough. Each slot of the plurality of slots includes a major axis oriented perpendicular to a centerline of the liner assembly.

In another aspect, an aircraft engine housing having a centerline and an axis extending through the engine housing parallel to the centerline is provided. The aircraft engine housing includes a nacelle including an inner surface and a core casing including an outer surface. The inner surface and the outer surface are configured to be exposed to an airflow traveling in a direction generally parallel to the axis. The aircraft engine housing also includes a liner assembly coupled to at least one of the inner surface and the outer surface. The liner assembly includes a core and a septum coupled to the core. The liner assembly also includes a facesheet coupled to the septum. The facesheet includes plurality of slots defined therethrough, wherein each slot of the plurality of slots includes a major axis oriented perpendicular to the centerline.

In another aspect, a method of assembling a liner assembly is provided. The method includes coupling a septum to a core and coupling a facesheet to the septum. The facesheet includes a plurality of slots defined therethrough, wherein each slot of the plurality of slots includes a major axis oriented perpendicular to a centerline of the liner assembly.

### BRIEF DESCRIPTION OF THE DRAWINGS

FIG. 1 is a schematic cross-sectional view of an embodiment of an aircraft engine including an engine housing;

FIG. 2 is an exploded perspective view of an exemplary liner assembly that may be used with the engine housing shown in FIG. 1;

FIG. 3 is a cross-sectional view of the liner assembly shown in FIG. 2;

FIG. 4 is an exploded side view of the liner assembly shown in FIG. 2 illustrating an exemplary facesheet, a septum, and a core;

FIG. 5 is top view of the facesheet shown in FIG. 4 illustrating a plurality of slots defined therethrough; and

FIG. 6 is a flowchart of an embodiment of a method of assembling the liner assembly shown in FIG. 2.

### DETAILED DESCRIPTION

The implementations described herein provide an apparatus and method for noise attenuation and drag reduction in an engine housing. The implementations describe a liner assembly that includes a core, a septum coupled to the core, and a facesheet coupled to the septum. The facesheet includes a plurality of slots defined therethrough. Each slot is elongated in a direction perpendicular to the direction of an airflow that is configured to travel over the facesheet. Furthermore, the septum is coupled to a top surface of the core such that the septum and the facesheet are in direct contact with one another. The embodiments described herein provide improvements over at least some known noise attenuation systems for engine housings. As compared to at least some known noise attenuation systems, the embodiments described herein facilitate reducing the drag induced by the slots during operation. More specifically, as described above, estimates and experimental testing have shown that orienting the slots in a direction perpendicular to the airflow direction reduces drag. Furthermore, combining the perpendicular orientation of the slots with the position of the septum being directly adjacent the facesheet further reduces the drag to unexpected levels comparable to that of a smooth facesheet having no slots or holes.

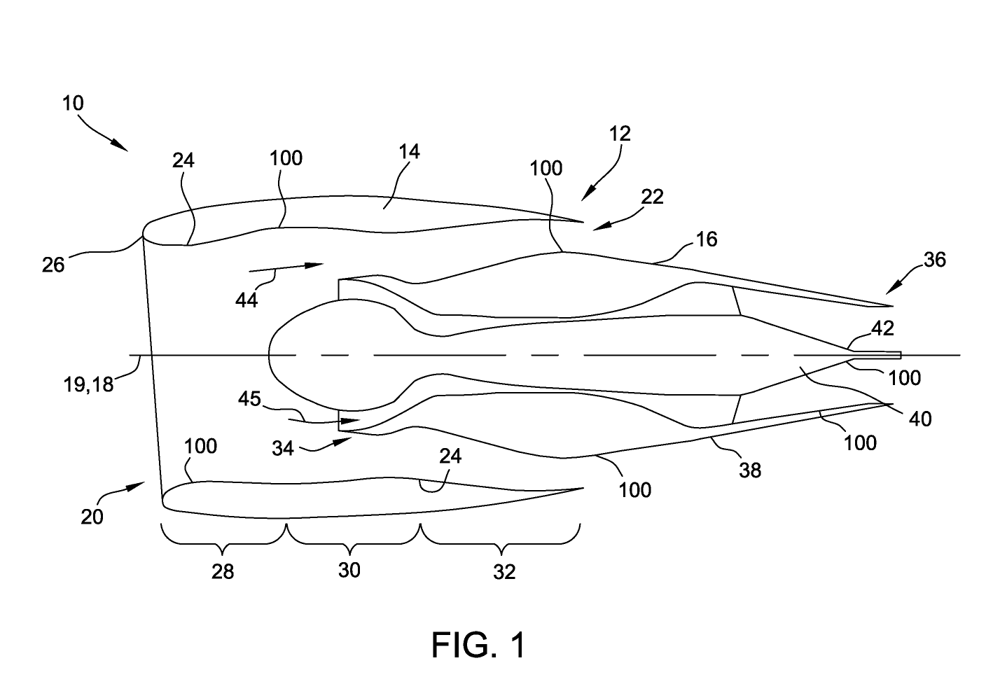

Referring more particularly to the drawings, implementations of the disclosure may be described in the context of an aircraft engine assembly 10 shown schematically in cross-section in FIG. 1. In an embodiment, engine assembly 10 includes a housing 12 including a nacelle 14 and a core casing 16. Nacelle 14 and core casing 16 enclose a turbofan engine for use with an aircraft. It should be understood, however, that the disclosure applies equally to nacelles and core casings for other types of engines, as well as to other structures subjected to noise-generating fluid flow in other applications, including but not limited to automobiles, heavy work vehicles, and other vehicles.

In the illustrated implementation, nacelle 14 and core casing 16 extend generally circumferentially about a centerline 18. Nacelle 14 includes a forward end 20, an aft end 22, and an inner surface 24 extending between ends 20 and 22. Nacelle 14 also includes, in a sequential forward to aft arrangement, a lip portion 26, an inlet portion 28, a fan case portion 30, and a fan duct portion 32. Inner surface 24 extends axially along each of lip portion 26, inlet portion 28, fan case portion 30, and fan duct portion 32. Similarly, core casing 16 includes a forward end 34, an aft end 36, and an outer surface 38 extending between ends 34 and 36. Core casing 16 also includes a nozzle portion 40 including an outer surface 42.

In the implementation, engine housing 12 includes a liner assembly 100 coupled to at least one of inner surface 24 of nacelle 14, outer surface 38 of core casing 16, and outer surface 42 of nozzle 40. During operation, liner assembly 100 is exposed to an airflow 44 traveling through housing 12 in the axial direction, that is, along an axis 19, which is parallel to centerline 18. As described herein, liner assembly 100 both attenuates noise generated by engine assembly 10 and also reduces drag created by airflow 44 along inner surface 24 and outer surface 38 and by an airflow 45 through core casing 16 and along outer surface 42. In one implementation, liner assembly 100 is coupled along an entire length of inner surface 24 between ends 20 and 22 of nacelle 14 and is also coupled along an entire length of at least one of outer surface 38 between ends 34 and 36 of core casing 16. In another implementation, liner assembly 100 is coupled to only a portion of at least one of inner surface 24 and outer surface 38. Generally, liner assembly 100 extends along at least one of inner surface 24 and outer surface 38 any length required to achieve the desired noise attenuation and drag reduction.

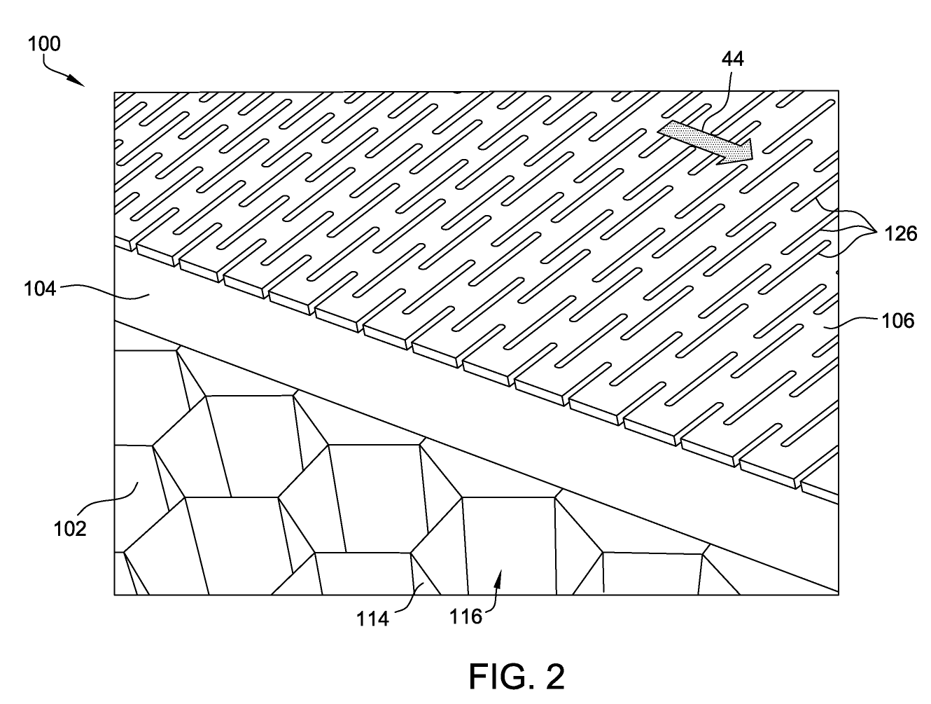

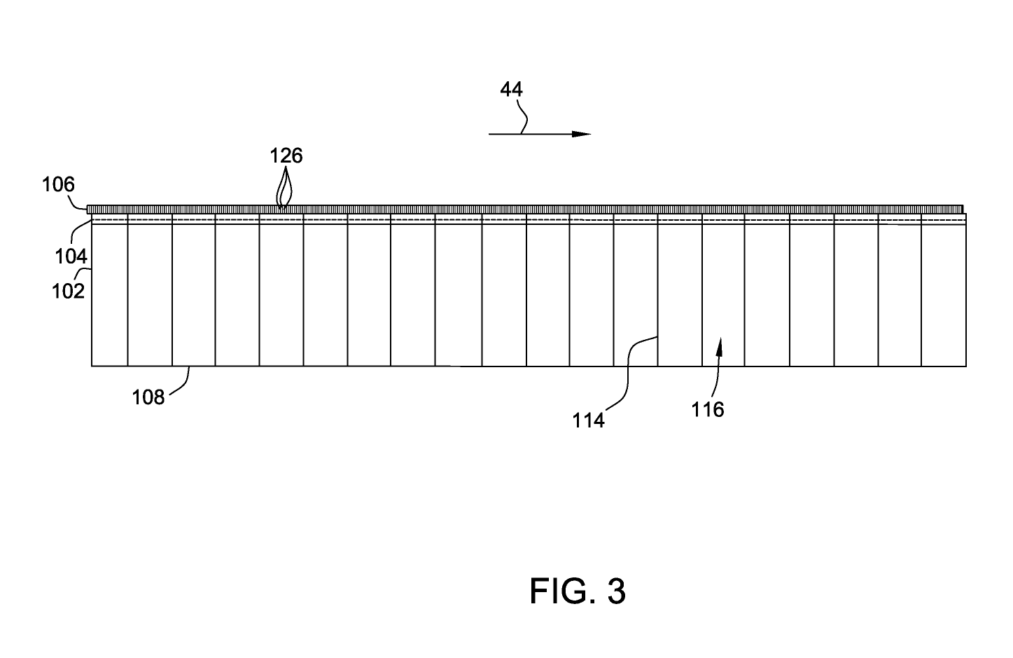

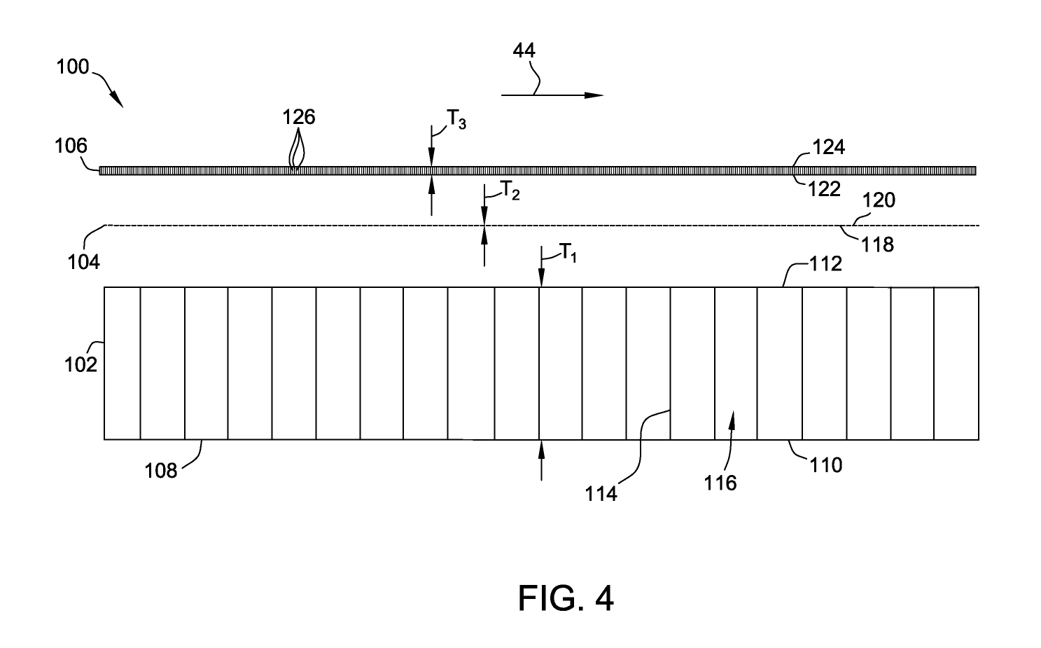

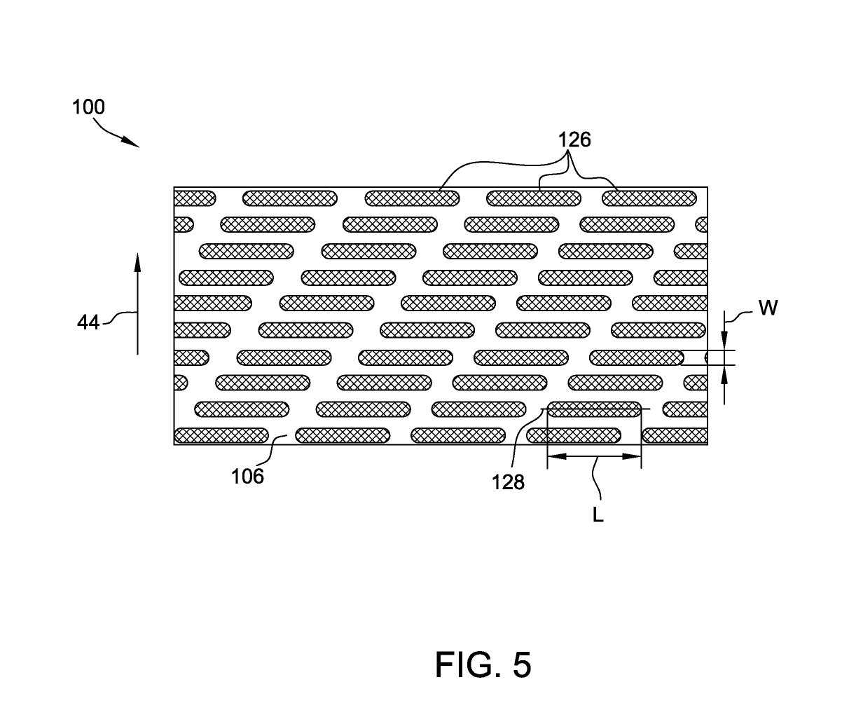

FIG. 2 is an exploded perspective view of liner assembly 100 that may be used with engine housing 12 (shown in FIG. 1). FIG. 3 is a cross-sectional view of liner assembly 100. FIG. 4 is an exploded side view of liner assembly 100, and FIG. 5 is top view of liner assembly 100.

Liner assembly 100 includes a core 102, a septum 104, and a facesheet 106 coupled to one another. Core 102 is coupled to at least one of inner surface 24 (shown in FIG. 1) and outer surface 38 (shown in FIG. 1), and facesheet 106 is exposed to airflows 44 and 45 when engine assembly 10 (shown in FIG. 1) is in an operational state. Liner assembly 100 also includes a backsheet 108 coupled to core 102 opposite facesheet 106. Backsheet 108 provides a cap to the individual cells of core 102 to facilitate noise attenuation. Backsheet 108, core 102, septum 104, and facesheet 106 are coupled together using diffusion bonding. Backsheet 108, core 102, septum 104, and facesheet 106 may be brazed or welded together, or in another implementation, may be coupled together using an adhesive. Generally, backsheet 108, core 102, septum 104, and facesheet 106 may be coupled together in any suitable fashion that enables liner assembly 100 to function as described herein.

As shown in FIGS. 2-5, core 102 includes a first surface 110 and an opposing second surface 112 having cell openings defined therethrough. First surface 110 is coupled to backsheet 108 and second surface 112 is coupled to septum 104. In one implementation, backsheet 108 closes first surface 110 such that first surface 110 is impermeable to air and, therefore, acoustic flow.

Furthermore, core 102 includes a plurality of cells 114 extending between surfaces 110 and 112 and arranged in a honeycomb pattern wherein each cell 114 has a generally hexagonal cross-section and includes a channel 116 defined therethrough. Generally, cells 114 may be shaped and arranged in any suitable pattern that enables core 102 to function as described herein. In the exemplary implementation, core cells 114 are full-depth cells, that is, cells 114 are continuous through core 102 between surfaces 110 and 112.

In one implementation, core 102 includes a thickness T1 in a range of approximately 0.1 in. (2.54 mm.) to approximately 4.0 in. (101.6 mm.). Generally, core 102 may have any thickness that facilitates operation of liner assembly 100 as described herein. More specifically, the thickness T1 of core 102 may be tuned to provide optimum noise attenuation for various jet engine and nacelle configurations. More specifically, the thickness T1 of core 102 may be based on the location of liner assembly within engine assembly 10. Additionally, core 102 is formed from fiberglass-reinforced phenolic resin. In alternative embodiments, core 102 is formed from another fiber-reinforced resin. In still other alternative embodiments, core 102 is formed from at least one of a plastic material, a metal, a coated paper material, or any other suitable material that enables core 102 to function as described herein.

In the exemplary implementation, septum 104 includes a first surface 118 and an opposing second surface 120. First surface 118 is coupled to second surface 112 of core 102 and second surface 120 is coupled to facesheet 106. As such, septum 104 is coupled between core 102 and facesheet 106 such that core 102 does not contact facesheet 106 and septum 104 is directly coupled to facesheet 106. In another implementation is septum 104 covers only the open areas of facesheet 106 such that facesheet 106 is directly coupled to core 102. In the illustrated implementation, septum 104 is coupled to core 102 using an adhesive. In certain implementations, the adhesive is a reticulated film adhesive to facilitate avoiding interference with the acoustic coupling of cells 114 and septum 104. In other implementations, septum 104 is coupled to core 102 in any suitable fashion that enables liner assembly 100 to function as described herein.

Septum 104 is formed at least partially from a material that provides substantially linear acoustic attenuation. In certain implementations, septum 104 is formed from a woven fabric, such as a fabric woven from thermoplastic fibers in the polyaryletherketone (PAEK) family. In an implementation, septum 104 is formed from at least one of a polyetherketoneketone (PEKK) and a polyether ether ketone (PEEK) woven fabric. As used herein, the term “linear material” is meant to describe any material that responds substantially the same to acoustic waves regardless of the sound pressure (i.e., amplitude) of the waves, to facilitate noise attenuation. With a linear material, the pores or passages defined therein may be configured such that resistance to pressure waves does not vary with the noise level, and the pressure drop across the material is relatively constant with respect to the pressure wave velocity. This is a result of the pressure losses primarily due to viscous or friction losses through the material.

Additionally, in certain implementations, septum 104 has a thickness T2 in a range of about 0.003 inches (0.0762 mm) to about 0.100 inches (2.54 mm). In an embodiment, septum 104 has a thickness T2 of about 0.005 inches (0.127 mm). In alternative implementations, septum 104 is formed from any suitable material and has any suitable thickness that enables septum 104 to function as described herein.

Liner assembly 100 includes facesheet 106 including a first surface 122 and an opposing second surface 124. First surface 122 is coupled to second surface 120 of septum 104 and second surface 124 is exposed to axially-oriented airflow 44. As best shown in FIG. 5, facesheet 106 includes a plurality of slots 126 extending therethrough from first surface 122 to second surface 124. Each slot 126 includes a major axis 128 that is oriented perpendicular to the direction of airflow 44. That is, each slot 126 is elongated such that each slot 126 defines a length L in a direction perpendicular to the direction of airflow 44 over facesheet 106. In an implementation, slots 126 include a length in a range of approximately 0.250 (6.35 mm) inches to approximately 1.500 inches (38.1 mm). As such, as liner assembly 100 extends circumferentially along inner surface 24 (shown in FIG. 1) of nacelle 14 (shown in FIG. 1) and/or outer surface 38 (shown in FIG. 1) of core casing 16 (shown in FIG. 1), slots 126 are oriented circumferentially with respect to centerline 18 (shown in FIG. 1). In the exemplary implementation, each slot 126 also defines a width W extending in the direction of airflow 44. More specifically, each slot 126 defines a width of approximately 0.005 inches (0.127 mm) to approximately 0.06 inches (1.524 mm). In another implementation, the width W of each slot 126 is a maximum of 0.06 inches (1.524 mm).

As shown in FIG. 5, slots 126 are elongated in a direction perpendicular to centerline 18 and, thus, airflow direction 44. Such a perpendicular orientation facilitates minimizing drag created by slots 126 for a certain open area. More specifically, experimental testing has shown that orienting slots 126 in a direction perpendicular to airflow direction 44 reduces drag. Furthermore, combining the perpendicular orientation of slots 126 with the position of septum 118 being directly adjacent facesheet 106 further reduces the drag to levels below that as would be expected according to estimates. Such experimental drag levels are comparable to that of a facesheet having no slots. Tests have shown that the smaller the width W of slots 126 oriented a direction perpendicular to centerline 18 (and airflow direction 44), the lower the measured drag levels.

In one implementation, slots 126 are spaced on facesheet 106 such that facesheet 106 has a porosity in a range of between approximately 5 percent open area (POA) to approximately 40 POA, and more specifically, between approximately 15 POA to approximately 30 POA. In an embodiment, slots 126 are spaced such that facesheet 106 has a porosity of approximately 20 POA. The relatively high porosity of facesheet 106 reduces the pressure loss through slots 126. Accordingly, the pressure within core 102 is approximately equal to the pressure along second surface 124 of facesheet 106, and slots 126 do not significantly affect the flow of air into and out of core 102 as sound waves pass over surface of facesheet 106. In some implementations, the percent open area of facesheet 106 is based on a percent open area of septum 104 such that facesheet 106 and septum 104 generate a predetermined combined flow resistance. For example, in implementations where septum 104 has a low percentage open area, facesheet 106 will have a high percent open area such that the combined flow resistance of facesheet 106 and septum 104 is within a predetermined range. Moreover, in the illustrated embodiment, slots 126 are disposed in a staggered pattern such that they alternate in axial position along a circumference of facesheet 106. In alternative embodiments, slots 126 may be disposed in any suitable pattern that enables facesheet 106 to function as described herein.

Facesheet 106 is made of a metallic material, such as, but not limited to, titanium, aluminum, or any other metallic material. Additionally, in another implementation, facesheet 106 is made of composite, resin, wood, or any material that holds stress and facilitates operation of liner assembly 100 as described herein. Furthermore, facesheet 106 includes a thickness T3 in a range of between approximately 0.05 inches (1.27 mm.) and approximately 0.1 inches (2.54 mm.). Generally, facesheet 106 may have any thickness T3 that facilitates operation of liner assembly 100 as described herein.

In at least some embodiments, a shape and spacing of slots 126 on facesheet 106 facilitate an increased linearity of, and acoustic attenuation by, liner assembly 100, as compared to at least some known perforated facesheets. Additionally, alignment of slots 126 perpendicular to centerline 18 (and the direction of airflow 44) facilitates minimizing drag created by slots 126. The shape and spacing of slots 126 also facilitates a decreased cost and time required to manufacture facesheet 106. For example, in a particular embodiment, facesheet 106 is used as part of nacelle 14 (shown in FIG. 1) for a turbofan engine, and facesheet 106 includes about 96,000 slots 126, wherein millions of perforations are required for a conventional facesheet in a similar application.

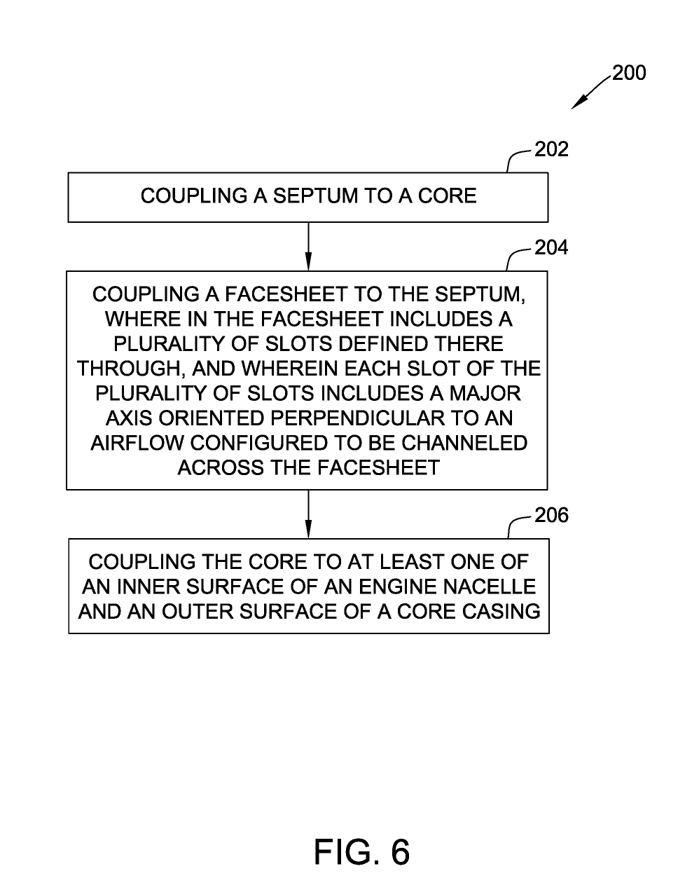

FIG. 6 is a flowchart of an embodiment of a method 200 of assembling a liner assembly, such as liner assembly 100. Method 200 includes coupling 202 a septum, such as septum 104, to a core, such as core 102, and then coupling 204 a facesheet, such as facesheet 106, to the septum. The facesheet includes a plurality of slots, such as slots 126, defined therethrough that each includes a major axis oriented perpendicular to a centerline, such as centerline 18, and thus perpendicular to an airflow, such as airflow 44, configured to be channeled across the facesheet. Method 200 further includes coupling 206 the core to at least one of an inner surface of an engine nacelle, such as inner surface 24 of nacelle 14, and an outer surface of a core casing, such as outer surface 38 of core casing 16.

Each of the processes of method 200 may be performed or carried out by a system integrator, a third party, and/or a customer. For the purposes of this description, a system integrator may include without limitation any number of aircraft manufacturers and major-system subcontractors; a third party may include without limitation any number of venders, subcontractors, and suppliers; and a customer may be an airline, leasing company, military entity, service organization, and so on. Moreover, although an aerospace example is shown, the principles of the invention may be applied to other industries, such as the automotive industry.

The embodiments described herein provide an apparatus and method for noise attenuation and drag reduction in an engine housing. The embodiments describe a liner assembly that includes a core, a septum coupled to the core, and a facesheet coupled to the septum. The facesheet includes a plurality of slots defined therethrough. Each slot is elongated in a direction perpendicular to the direction of an airflow that is configured to travel over the facesheet. Furthermore, the septum is coupled to a top surface of the core such that the facesheet and the core do not contact one another. The embodiments described herein provide improvements over at least some known noise attenuation systems for engine housings. As compared to at least some known noise attenuation systems, the embodiments described herein facilitate reducing the drag induced by the slots during operation. More specifically, as described above, experimental testing has shown that orienting the slots in a direction perpendicular to the airflow direction reduces drag. Furthermore, combining the perpendicular orientation of the slots with the position of the septum being directly adjacent the facesheet further reduces the drag to unexpected levels comparable to that of a facesheet having no slots.

This written description uses examples to disclose various implementations, which include the best mode, to enable any person skilled in the art to practice those implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A liner assembly comprising:
a core;
a septum coupled to said core; and
a facesheet coupled to said septum, said facesheet comprising a plurality of slots defined therethrough, wherein each slot of said plurality of slots comprises a major axis oriented perpendicular to a centerline of the liner assembly.

2. The liner assembly in accordance with claim 1, wherein said septum is coupled between said core and said facesheet.

3. The liner assembly in accordance with claim 2, wherein said core comprises a first surface and said septum comprises a second surface coupled to said core first surface.

4. The liner assembly in accordance with claim 2, wherein said septum is coupled between said core and said facesheet such that said core does not contact said facesheet.

5. The liner assembly in accordance with claim 1, wherein said plurality of slots define a width of approximately 0.005 inches to approximately 0.06 inches.

6. The liner assembly in accordance with claim 1, wherein said plurality of slots include a maximum width of 0.06 inches.

7. The liner assembly in accordance with claim 1, wherein said facesheet has a porosity in a range of between approximately 5 percent to approximately 40 percent open area.

8. An aircraft engine housing having a centerline and an axis extending through the engine housing parallel to the centerline, said aircraft engine housing comprising:
a nacelle comprising an inner surface;
a core casing comprising an outer surface, wherein said inner surface and said out surface are configured to be exposed to an airflow traveling in a direction generally parallel to the axis; and
a liner assembly coupled to at least one of said inner surface and said outer surface, said liner assembly comprising:
a core;
a septum coupled to said core; and
a facesheet coupled to said septum, said facesheet comprising a plurality of slots defined therethrough, wherein each slot of said plurality of slots comprises a major axis oriented perpendicular to the centerline.

9. The aircraft engine housing in accordance with claim 8, wherein said plurality of slots are oriented circumferentially with respect to the centerline.

10. The aircraft engine housing in accordance with claim 8, wherein said facesheet is coupled to an entirety of at least one of said inner surface and said outer surface.

11. The aircraft engine housing in accordance with claim 8, wherein said facesheet is coupled to only a portion of at least one of said inner surface and said outer surface.

12. The aircraft engine housing in accordance with claim 8, wherein said plurality of slots include a maximum width of 0.06 inches.

13. The aircraft engine housing in accordance with claim 8, wherein said septum is coupled between said core and said facesheet.

14. The aircraft engine housing in accordance with claim 8, wherein said facesheet has a porosity in a range of between approximately 5 percent to approximately 40 percent open area.

15. A method of assembling a liner assembly, said method comprising:
coupling a septum to a core; and
coupling a facesheet to the septum, wherein the facesheet includes a plurality of slots defined therethrough, and wherein each slot of the plurality of slots includes a major axis oriented perpendicular to a centerline of the liner assembly.

16. The method in accordance with claim 15, further comprising coupling the core to an inner surface of an engine nacelle.

17. The method in accordance with claim 15 further comprising coupling the core to an outer surface of a core casing.

18. The method in accordance with claim 15, wherein coupling the septum to the core comprises coupling a first surface of the septum to a second surface of the core.

19. The method in accordance with claim 15, wherein coupling the facesheet to the septum comprises coupling the facesheet to the septum such that the facesheet does not contact the core.

20. The method in accordance with claim 15, wherein coupling the facesheet to the septum comprises coupling the facesheet including a plurality of slots that each include a width between 0.005 inches and 0.06 inches.
